(19) United States
(12) Patent Application Publication
(10) Pub. No.: US 2025/0136070 A1
(43) Pub. Date: May 1, 2025

(54) METHOD OF TRAILER SAFETY CONTROL, AND TRAILER SAFETY DEVICE AND SYSTEM USING SAME

(71) Applicant: UC UniK Technology Ltd., New Taipei City (TW)

(72) Inventor: Teng-Yong WANG, New Taipei City (TW)

(73) Assignee: UC UniK Technology Ltd., New Taipei City (TW)

(21) Appl. No.: 18/890,442

(22) Filed: Sep. 19, 2024

Related U.S. Application Data
(60) Provisional application No. 63/545,772, filed on Oct. 26, 2023.

(51) Int. Cl. B60T 7/20; B60D 1/62; B60R 16/033; G07C 5/08; H02J 7/00; H02J 7/35

(52) U.S. Cl. CPC B60T 7/20; B60D 1/62; B60R 16/033; G07C 5/0825; H02J 7/0048; H02J 7/35

(57) ABSTRACT

A method of trailer safety control is to be implemented by a trailer safety system that includes a trailer safety device. The trailer safety device includes a processing unit, a charging unit, a state monitor, and a wireless communication unit that are connected to the processing unit, a battery that is connected to the charging unit, and a breakaway switch that is connected to the battery. The method includes, when the charging unit receives an external power supply from an external power supply terminal, the processing unit controlling the charging unit to charge the battery using the external power supply, and the processing unit operating in an active mode that includes operations of, establishing a wireless network connection with an electronic device, controlling the state monitor to monitor trailer states, and transmitting an alert notification to the electronic device when a trailer is separated from a tow vehicle.

### CROSS-REFERENCE TO RELATED APPLICATION

This application claims the benefit of U.S. Provisional Patent Application No. 63/545,772, filed on Oct. 26, 2023, the entire disclosure of which is incorporated by reference herein.

### FIELD

The disclosure relates to a method of control, and more particularly to a method of trailer safety control. The disclosure further relates to a trailer safety device and a trailer safety system using the method of trailer safety control.

### BACKGROUND

In modern society, using a trailer to carry goods and using a tow vehicle to tow the trailer is a common way of transporting goods. The tow vehicle and the trailer are usually connected to each other through a trailer hitch and a coupler.

However, once the trailer hitch or the coupler is aged or worn, the trailer may accidentally separate from the tow vehicle while the tow vehicle is being driven by a driver, posing a threat to the safety of other road users. Moreover, if the driver of the tow vehicle does not immediately notice the separation of the trailer, traffic safety may be further jeopardized.

### SUMMARY

Therefore, an object of the disclosure is to provide a method of trailer safety control, and a trailer safety device and a trailer safety system using the method of trailer safety control, that can alleviate at least one of the drawbacks of the prior art.

According to an aspect of the disclosure, the method is to be implemented by a trailer safety system. The trailer safety system includes a trailer safety device adapted to be mounted on a trailer. The trailer safety device includes a processing unit, a charging unit, a state monitor and a wireless communication unit that are electrically connected to the processing unit, a battery that is electrically connected to the charging unit, and a breakaway switch that is electrically connected to the battery. The breakaway switch has a non-conducting state and a conducting state, is caused to switch from the non-conducting state to the conducting state when the trailer is separated from a tow vehicle, and, when the breakaway switch is in the conducting state, provides electric power from the battery to an electronic braking system that is mounted on the trailer for activating the electronic braking system. The method includes, when the charging unit receives an external power supply from an external power supply terminal, the processing unit controlling the charging unit to charge the battery using the external power supply, and the processing unit operating in an active mode that includes operations of, establishing a wireless network connection with an electronic device via the wireless communication unit, controlling the state monitor to monitor trailer states that include a trailer connection status indicating a status of connection of the trailer with the tow vehicle, and transmitting an alert notification to the electronic device via the wireless communication unit when the trailer connection status indicates that the trailer is separated from the tow vehicle.

According to another aspect of the disclosure, the trailer safety device is adapted to be mounted on a trailer. The trailer includes an electronic braking system. The trailer safety device includes a processing unit, a charging unit, a state monitor, a wireless communication unit, a battery, and a breakaway switch. The processing unit is adapted to be wirelessly connected to an electronic device. The charging unit, the state monitor, and the wireless communication unit are electrically connected to the processing unit. The battery is electrically connected to the charging unit. The breakaway switch is electrically connected to the battery, has a non-conducting state and a conducting state, and is adapted to be electrically connected to the electronic braking system of the trailer. The breakaway switch is caused to switch from the non-conducting state to the conducting state when the trailer is separated from a tow vehicle, thereby providing electric power from the battery to the electronic braking system of the trailer for activating the electronic braking system. The processing unit is configured to, when the charging unit receives an external power supply from an external power supply terminal, control the charging unit to charge the battery using the external power supply, and operate in an active mode. The processing unit is further configured to, when operating in the active mode, establish a wireless network connection with the electronic device via the wireless communication unit, control the state monitor to monitor trailer states that include a trailer connection status indicating a status of connection of the trailer with the tow vehicle, and transmit an alert notification to the electronic device via the wireless communication unit when the trailer connection status indicates that the trailer is separated from the tow vehicle.

According to yet another aspect of the disclosure, the trailer safety system includes a trailer safety device. The trailer safety device is adapted to be mounted on a trailer that includes an electronic braking system. The trailer safety device includes a processing unit, a charging unit, a state monitor, a wireless communication unit, a battery, and a breakaway switch. The processing unit is adapted to be wirelessly connected to an electronic device. The charging unit, the state monitor, and the wireless communication unit are electrically connected to the processing unit. The battery is electrically connected to the charging unit. The breakaway switch is electrically connected to the battery, has a non-conducting state and a conducting state, and is adapted to be electrically connected to the electronic braking system of the trailer. The breakaway switch is caused to switch from the non-conducting state to the conducting state when the trailer is separated from a tow vehicle, thereby providing electric power from the battery to the electronic braking system of the trailer for activating the electronic braking system. The processing unit is configured to, when the charging unit receives an external power supply from an external power supply terminal, control the charging unit to charge the battery using the external power supply, and operate in an active mode. The processing unit is further configured to, when operating in the active mode, establish a wireless network connection with the electronic device via the wireless communication unit, control the state monitor to monitor trailer states that include a trailer connection status indicating a status of connection of the trailer with the tow vehicle, and transmit an alert notification to the electronic device via the wireless communication unit when the trailer connection status indicates that the trailer is separated from the tow vehicle.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a trailer safety system according to an embodiment of the present disclosure, a battery port that is disposed on a tow vehicle and adapted to be connected to the trailer safety system, and an electronic braking system and a solar panel that are disposed on a trailer, and that are adapted to be connected to the trailer safety system.

FIG. 2 is a flow chart illustrating a method of trailer safety control according to an embodiment of the present disclosure.

FIG. 3 is a flow chart illustrating operations of a first processing unit when the first processing unit is operating in an active mode according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

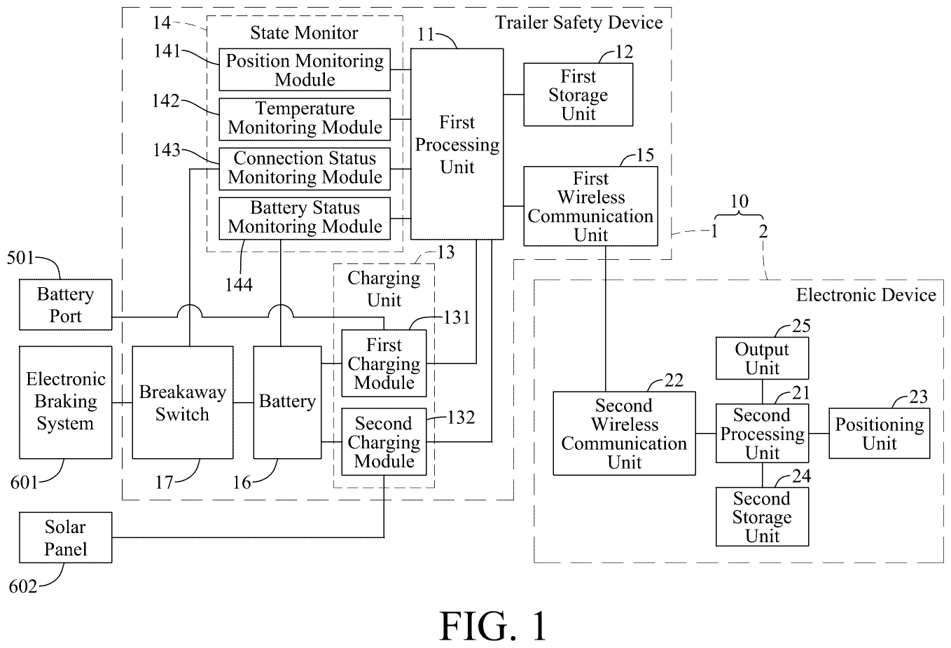

Referring to FIG. 1, a trailer safety system 10 according to an embodiment of the present disclosure is provided. The trailer safety system 10 is implemented on a trailer and a tow vehicle. The trailer and the tow vehicle are connected to each other through a connector mechanism (e.g., a trailer hitch and a coupler) that is already available in the market. When the trailer is connected to the tow vehicle, the trailer is towed by the tow vehicle, and move together with the tow vehicle.

In this embodiment, the trailer safety system 10 includes a trailer safety device 1 and an electronic device 2. The trailer safety device 1 is mounted on the trailer. The electronic device 2 is exemplified by a portable mobile device such as a smart phone, and is used for operation by a driver of the tow vehicle. In some embodiments, the trailer safety system 10 may be embodied using the trailer safety device 1 alone. That is to say, in such embodiments, the trailer safety system 10 does not include the electronic device 2.

The trailer safety device 1 includes a first processing unit 11, a first storage unit 12, a charging unit 13, a state monitor 14 and a first wireless communication unit 15 that are electrically connected to the first processing unit 11, a battery 16 that is electrically connected to the charging unit 13 and the state monitor 14, and a breakaway switch 17 that is electrically connected to the battery 16 and the state monitor 14. The breakaway switch 17 has a non-conducting state and a conducting state, and is electrically connected to an electronic braking system 601 that is mounted on the trailer. Specifically, the breakaway switch 17 is electrically connected between the battery 16 and the electronic braking system 601.

In this embodiment, the first processing unit 11 is exemplified by a processor that is realized by an integrated circuit (IC) and that has data processing and instruction handling capabilities. However, in other embodiments, the first processing unit 11 may also be a circuit assembly that includes a processor and a circuit board.

In this embodiment, the first storage unit 12 is a memory module capable of storing digital data, and may be exemplified by a flash memory. However, in other embodiments, the first storage unit 12 may be other types of computer-readable storage media, or a collection of multiple computer-readable storage media, either of the same or different types.

The charging unit 13 includes a first charging module 131 and a second charging module 132. The first charging module 131 and the second charging module 132 are each electrically connected to the first processing unit 11 and the battery 16. Each of the first charging module 131 and the second charging module 132 sends a power supply status signal to the first processing unit 11 in order for the first processing unit 11 to determine whether the first charging module 131 and the second charging module 132 are currently receiving any supply of power.

The first charging module 131 is exemplified by a battery charger IC, and is electrically connected to an external power supply terminal. In this embodiment, the external power supply terminal is exemplified by a battery port 501 of the tow vehicle. Specifically, the battery port 501 is electrically connected to an automotive battery (not shown) of the tow vehicle. The battery port 501 is configured in such a way that, for example, when the tow vehicle is in an engine-on state where an engine of the tow vehicle is started and is running, the battery port 501 outputs electric power that is stored in the automotive battery of the tow vehicle, and when the tow vehicle is in an engine-off state where the engine of the tow vehicle is not running (i.e., an ignition switch of the tow vehicle is in an off position), the battery port 501 does not output the electric power that is stored in the automotive battery of the tow vehicle. Therefore, when the tow vehicle is in the engine-on state, the first charging module 131 receives an external power supply (i.e., the electric power from the automotive battery of the tow vehicle) through the battery port 501, and the first processing unit 11 then controls the first charging module 131 to charge the battery 16 using the external power supply. In other embodiments, the external power supply terminal may be a connector terminal of a power adapter, where the power adapter is connected to a mains electricity outlet. However, the external power supply terminal is not limited to the examples of this disclosure.

The second charging module 132 is exemplified by a solar charging controller that uses the maximum power point tracking (MPPT) technique. The second charging module 132 is electrically connected to a solar panel 602 that is mounted on the trailer. As the solar panel 602 receives sun light, the second charging module 132 receives a solar power supply from the solar panel 602, and the first processing unit 11 controls the second charging module 132 to charge the battery 16 using the solar power supply from the solar panel 602.

The state monitor 14 includes a position monitoring module 141 that is electrically connected to the first processing unit 11, a temperature monitoring module 142 that is electrically connected to the first processing unit 11, a connection status monitoring module 143 that is electrically connected to the breakaway switch 17 and the first processing unit 11, and a battery status monitoring module 144 that is electrically connected to the battery 16 and the first processing unit 11.

The position monitoring module 141 is exemplified by a satellite positioning module, such as, but not limited to, a Global Positioning System (GPS) module, which uses satellite positioning techniques.

The temperature monitoring module 142 includes a temperature sensor. In some embodiments, the temperature sensor may be disposed on the battery 16 for measuring a temperature of the battery 16.

The connection status monitoring module 143 receives a conduction status signal from the breakaway switch 17, and based on the conduction status signal, the connection status monitoring module 143 determines whether the breakaway switch 17 is currently in the conducting state or the non-conducting state.

The battery status monitoring module 144 includes a voltage sensing circuit that is electrically connected to the battery 16. The voltage sensing circuit is used for measuring an output voltage of the battery 16. In this embodiment, the battery status monitoring module 144 converts a sensing result (i.e., the output voltage of the battery 16) of the voltage sensing circuit into a percentage value that corresponds with an amount of electric power currently remaining in the battery 16. In some embodiments, the battery status monitoring module 144 further includes a current sensing circuit that is electrically connected to the battery 16. The current sensing circuit is used for measuring an input current that is flowing into the battery 16 during charging, and an output current that is flowing out of the battery 16 during discharging. With this configuration, the input current and the output current that are measured may be used in an overcurrent protection mechanism of the battery 16.

The first wireless communication unit 15 is exemplified by a Bluetooth® communication module that uses the Bluetooth® Low Energy (BLE) technology. However, in other embodiments, the first wireless communication unit 15 may use other types of short-range wireless communication technologies.

The battery 16 is, for example, but is not limited to, a lead-acid battery with a total capacity of five ampere-hour (Ah). In this embodiment, the battery 16 is detachably disposed on the trailer safety device 1. However, in other embodiments, the battery 16 may be fixedly disposed on the trailer safety device 1. In this embodiment, the battery 16 is used to power the first processing unit 11, the first storage unit 12, the state monitor 14, and the first wireless communication unit 15.

The breakaway switch 17 is used in cooperation with a pin (not shown) that is attached to a cable secured to the tow vehicle. Specifically, when the pin is inserted into the breakaway switch 17, the pin breaks an electrical connection between two conductive spring plates (not shown) of the breakaway switch 17 that are electrically and respectively connected to the battery 16 and the electronic brake system 601, resulting in the breakaway switch 17 switching into the non-conducting state. On the other hand, when the pin is pulled out from the breakaway switch 17, the two conductive spring plates of the breakaway switch 17 re-establish the electrical connection between the two conductive spring plates, resulting in the breakaway switch 17 switching into the conducting state. It is noted that, a difference in voltages of the two conductive spring plates is measured and is outputted by the breakaway switch 17 as the conduction status signal. When the conduction status signal indicates a high voltage level (e.g., 12 volts), the connection status monitoring module 143 determines that the breakaway switch 17 is currently in the non-conducting state. On the other hand, when the conduction status signal indicates a low voltage level (e.g., 0 volts), the connection status monitoring module 143 determines that the breakaway switch 17 is currently in the conducting state.

Furthermore, when the breakaway switch 17 is in the non-conducting state, the battery 16 and the electronic braking system 601 of the trailer are not electrically connected to each other, and because of this, the battery 16 is not able to provide electric power stored therein to the electronic braking system 601 through the breakaway switch 17. On the other hand, when the breakaway switch 17 is in the conducting state, the battery 16 and the electronic braking system 601 of the trailer are electrically connected to each other, and because of this, the battery 16 is able to provide the electric power stored therein to the electronic braking system 601 through the breakaway switch 17, thereby activating the electronic braking system 601.

Therefore, when the trailer is separated from the tow vehicle, the pin attached via the cable to the tow vehicle is pulled out from the breakaway switch 17 as the tow vehicle continues to be driven forward, thereby causing the breakaway switch 17 to switch from the non-conducting state to the conducting state. When the breakaway switch 17 is switched into the conducting state, the breakaway switch 17 provides the electric power from the battery 16 to the electronic braking system 601 of the trailer, thereby activating the electronic braking system 601, and causing the trailer to stop moving.

The electronic device 2 includes a second processing unit 21, and a second wireless communication unit 22, a positioning unit 23, a second storage unit 24, and an output unit 25 that are electrically connected to the second processing unit 21. The second processing unit 21 is exemplified in the same manner as the first processing unit 11 of the trailer safety device 1. The second wireless communication unit 22 is exemplified in the same manner as the first wireless communication unit 15 of the trailer safety device 1. The positioning unit 23 is exemplified in the same manner as the position monitoring module 141 of the trailer safety device 1. The second storage unit 24 is exemplified in the same manner as the first storage unit 12 of the trailer safety device 1. The output unit 25 is exemplified by, for example, a display (not shown) and a speaker (not shown) that are electrically connected to the second processing unit 21. In this embodiment, the second storage unit 24 is pre-installed with an application program, and the second processing unit 21, by running the application program in the background, is wirelessly connected to the first processing unit 11 of the trailer safety device 1 through the second wireless communication unit 22.

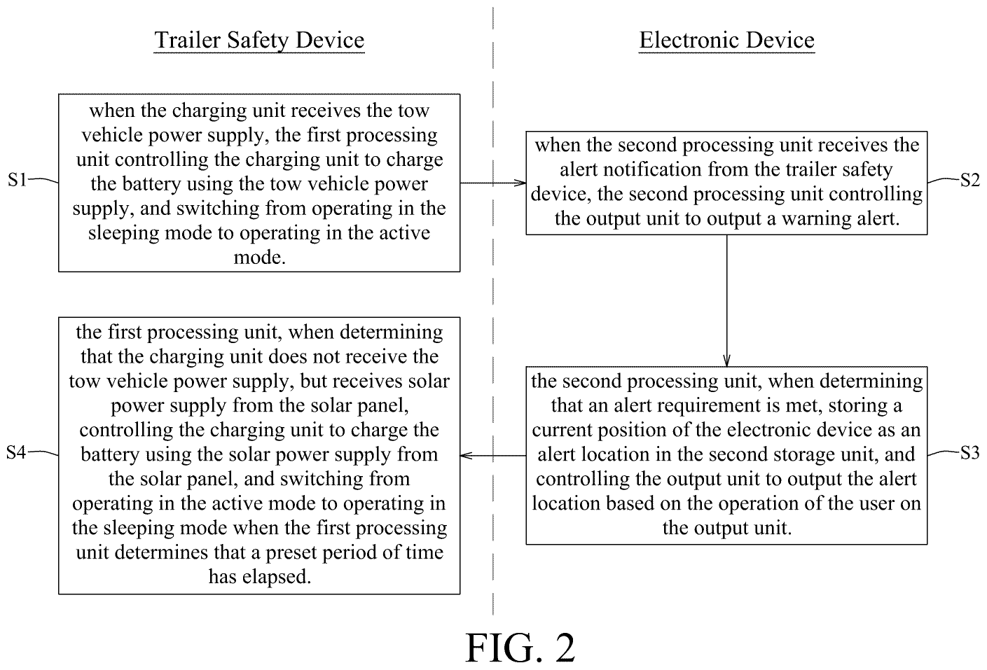

Referring to FIGS. 1 and 2, a method of trailer safety control which is to be implemented by the trailer safety system 10 is provided according to the present disclosure. In the following illustration, the method includes steps S1 to S4, and the first processing unit 11 of the trailer safety device 1 is operating in a sleeping mode before the flow goes to S1.

In step S1, when the first processing unit 11 determines that the first charging module 131 of the charging unit 13 receives the electric power from the automotive battery of the tow vehicle (hereinafter referred to as “the tow vehicle power supply”), the first processing unit 11 controls the first charging module 131 to charge the battery 16 using the tow vehicle power supply. At the same time, the first processing unit 11 switches from operating in the sleeping mode to operating in an active mode.

Specifically, when the tow vehicle switches from the engine-off state to the engine-on state, the battery port 501 starts to output the tow vehicle power supply to the first charging module 131. The first processing unit 11 then controls the first charging module 131 to charge the battery 16 using the tow vehicle power supply, and the first processing unit 11 switches to operating in the active mode.

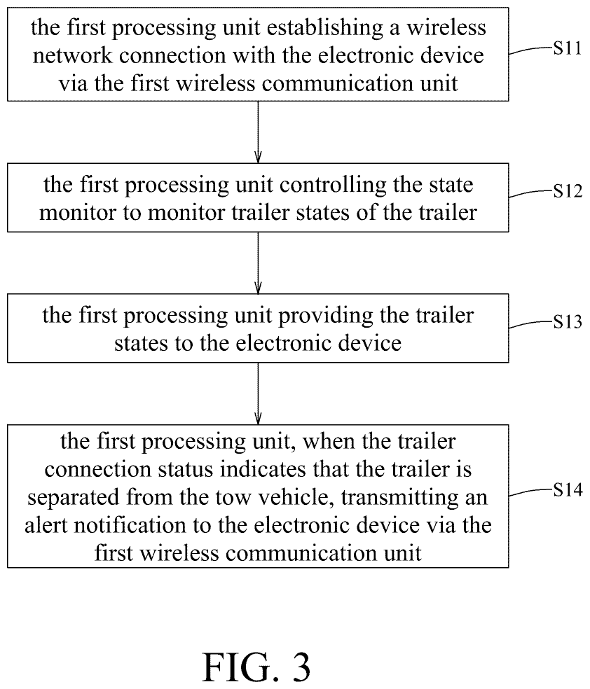

Referring to FIG. 3, operations of the first processing unit 11 after the first processing unit 11 switches from operating in the sleeping mode to operating in the active mode are illustrated below. The operations include steps S11 to S14.

In step S11, the first processing unit 11 automatically establishes a wireless network connection with the second processing unit 21 of the electronic device 2 via the first wireless communication unit 15. By establishing the wireless network connection, the first processing unit 11 is able to wirelessly communicate with the second processing unit 21.

The flow then goes to step S12. In step S12, the first processing unit 11 controls the state monitor 14 to monitor trailer states of the trailer.

Specifically, in this embodiment, a way in which the first processing unit 11 controls the state monitor 14 to monitor the trailer states is that the first processing unit 11 controls the position monitoring module 141 to continuously perform satellite positioning, controls the temperature monitoring module 142 to continuously perform temperature measurement, controls the connection status monitoring module 143 to continuously detect whether the breakaway switch 17 is in the non-conducting state or the conducting state, and controls the battery status monitoring module 144 to continuously measure the output voltage of the battery 16, and to generate a percentage value that corresponds with the amount of electric power currently remaining in the battery 16.

To be more specific, in this embodiment, the trailer states include positioning data generated by the position monitoring module 141, temperature data generated by the temperature monitoring module 142, a trailer connection status generated by the connection status monitoring module 143, and a battery status generated by the battery status monitoring module 144.

The positioning data indicates a current position of the position monitoring module 141, which is equivalent to indicating a current position of the trailer. The temperature data indicates a current temperature of the trailer safety device 1. In some embodiments, the current temperature indicated by the temperature data is regarded as corresponding to a current temperature of the battery 16. The trailer connection status indicates whether the breakaway switch 17 is currently in the non-conducting state or the conducting state, which is equivalent to indicating whether the trailer and the tow vehicle are currently connected to each other or separated from each other. Specifically, if the trailer connection status indicates that the breakaway switch 17 is in the non-conducting state, it is equivalent to indicating that the trailer and the tow vehicle are connected to each other. On the contrary, if the trailer connection status indicates that the breakaway switch 17 is in the conducting state, it is equivalent to indicating that the trailer and the tow vehicle are separated from each other. The battery status includes the percentage value of electric power currently still available, which is equivalent to indicating the amount of electric power currently remaining in the battery 16.

In step S13, the first processing unit 11 provides the trailer states to the electronic device 2 through the first wireless communication unit 15 to make the electronic device 2 display the trailer states. Specifically, the second processing unit 21 of the electronic device 2, in response to receipt of the trailer states, controls the display of the output unit 25 to display the trailer states. With this configuration, a user (e.g., the driver of the tow vehicle) may view the trailer states on the electronic device 2, especially the battery status of the trailer in order to check whether the amount of electric power currently remaining in the battery 16 is sufficient to activate the electronic braking system 601.

In step S14, when the trailer connection status indicates that the trailer is separated from the tow vehicle (i.e., the trailer connection status indicating that the breakaway switch 17 is in the conducting state), the first processing unit 11 transmits an alert notification to the electronic device 2 via the first wireless communication unit 15.

When the first processing unit 11 is operating in the active mode and after step S14 has been performed, the flow then goes to step S2 of FIG. 2.

In step S2, when the second processing unit 21 of the electronic device 2 receives the alert notification from the first processing unit 11 of the trailer safety device 1, the second processing unit 21 controls the output unit 25 to output a warning alert. In this embodiment, the second processing unit 21 controls the output unit 25 to output the warning alert by, for example, controlling the display to display an alert message, and controlling, at the same time, the speaker to output an alert sound. With this configuration, when the trailer is accidentally separated from the tow vehicle while the tow vehicle is being driven by a driver, the trailer safety system 10 of the present disclosure is able to automatically notify the driver of the tow vehicle, so that the driver may take action immediately.

In step S3, when the second processing unit 21 of the electronic device 2 determines that an alert requirement is met, the second processing unit 21 stores a current position of the positioning unit 23 that is generated by the positioning unit 23 (i.e., equivalent to a current position of the electronic device 2) as an alert location in the second storage unit 24. The second processing unit 21 further controls the display of the output unit 25 to display the alert location for viewing by the user (e.g., the driver) based on an operation of the user on the output unit 25.

In this embodiment, the alert requirement is that the second processing unit 21 of the electronic device 2 loses the wireless network connection with the first processing unit 11 of the trailer safety device 1 when the first processing unit 11 of the trailer safety device 1 is operating in the active mode. For example, when the tow vehicle continues to be driven forward after the trailer is separated from the tow vehicle, a distance between the trailer and the tow vehicle continues to increase as well. Once the distance exceeds a range of communication of the first wireless communication unit 15 and the second wireless communication unit 22, the wireless network connection between the first processing unit 11 and the second processing unit 21 is lost, and the second processing unit 21 determines that the alert requirement is met.

In other embodiments, when the second processing unit 21 of the electronic device 2 determines that the alert requirement is met, the second processing unit 21 further controls the output unit 25 to immediately output another warning alert in case the driver of the tow vehicle does not see the warning alert outputted by the electronic device 2 earlier in step S2. Optionally, the second processing unit 21 of the electronic device 2 may transmit the alert location to a cloud server (not shown), in order for the cloud server to store the alert location, or to transmit the alert location to other relevant personnel to notify them.

In step S4, when the first processing unit 11 determines that the first charging module 131 of the charging unit 13 does not receive the tow vehicle power supply but the second charging module 132 receives the solar power supply from the solar panel 602, the first processing unit 11 controls the second charging module 132 to charge the battery 16 using the solar power supply from the solar panel 602, so that the battery 16 may be automatically charged under sunny environment. Besides that, when the first processing unit 11 determines that a preset period of time has elapsed since the first charging module 131 stopped receiving the tow vehicle power supply, the first processing unit 11 switches from operating in the active mode to operating in the sleeping mode. The preset period of time is counted, for example, from the time when the first processing unit 11 determines that the first charging module 131 has stopped receiving the tow vehicle power supply. The preset period of time may be, for example, three minutes, five minutes, or other predetermined time length.

In this embodiment, when the first processing unit 11 switches from operating in the active mode to operating in the sleeping mode, the first processing unit 11 performs operations that include cutting off the wireless network connection with the second processing unit 21 (i.e., equivalent to the first processing unit 11 actively disconnecting itself from the electronic device 2), controlling the state monitor 14 to stop monitoring (i.e., equivalent to controlling the state monitor 14 to stop generating trailer states), and controlling the second charging module 132, in a case where the second charging module 132 is receiving the solar power supply, to charge the battery 16.

In some other embodiments, even when the first processing unit 11 is operating in the sleeping mode, the first processing unit 11 may still periodically control the battery status monitoring module 144 to generate the battery status, and transmit the battery status to the electronic device 2 while the first processing unit 11 is still connected wirelessly with the electronic device 2, so that the user (e.g., the driver) may check the amount of electric power currently remaining in the battery 16 at any time.

Besides that, when the first processing unit 11 determines that the first charging module 131 has stopped receiving the tow vehicle power supply, and that the second charging module 132 has not received any solar power supply from the solar panel 602, the first processing unit 11 may still switch from operating in the active mode to operating in the sleeping mode after the preset period of time has elapsed.

The description above explains how an embodiment of the trailer safety system 10 according to the present disclosure implements the method for trailer safety control.

The description above is based on the assumption that the trailer is accidentally separated from the tow vehicle. In a case where the trailer remains connected with the tow vehicle, after the first processing unit 11 provides the trailer states to the electronic device 2 (i.e., operation in step S13), the first processing unit 11 does not proceed to step S14. In another case where the tow vehicle together with the trailer reaches a destination, and an engine of the tow vehicle is turned off by the driver (i.e., the tow vehicle switches from the engine-on state to the engine-off state), the first processing unit 11 may switch from operating in the active mode to operating in the sleeping mode after the preset period of time has elapsed (i.e., operation in step S4).

In addition, in this embodiment, when the first processing unit 11 is operating in the sleeping mode, only when the first processing unit 11 determines that the first charging module 131 starts to receive the tow vehicle power supply will the first operating unit 11 switch from operating in the sleeping mode to operating in the active mode. That is to say, when the first operating unit 11 is operating in the sleeping mode, even when the second charging module 132 is receiving the solar power supply, the first processing unit 11 will still continue to operate in the sleeping mode.

When the first processing unit 11 determines that the first charging module 131 and the second charging module 132 are both receiving power supplies, the first processing unit 11 may control the first charging module 131 to charge the battery 16, and control the second charging module 132 to not charge the battery 16. In other words, when the charging unit 13 receives the tow vehicle power supply from the tow vehicle and the solar power supply from the solar panel 602 at the same time, the first processing unit 11 may control the charging unit 13 to prioritize charging the battery 16 using the tow vehicle power supply. However, in other embodiments, when the first processing unit 11 determines that the first charging module 131 and the second charging module 132 are both receiving power supplies, the first processing unit 11 may control the first charging module 131 and the second charging module 132 to both charge the battery 16 at the same time. Specifically, in some embodiments, when the first processing unit 11 is operating in the active mode, the first processing unit 11 may still control the second charging module 132 to charge the battery 16 using the solar power supply from the solar panel 602. Therefore, solar energy may be used to charge the battery 16 when the first processing unit 11 is operating in the active mode.

It should be noted that the steps S1 to S4, the steps S11 to S14, and the flowcharts in FIGS. 2 and 3 according to this embodiment are used only to illustrate one possible implementation of the method of trailer safety control of the present disclosure. It should be understood that when the steps S1 to S4 are merged, split, or adjusted in sequence, if the flow of the process after merging, splitting or adjusting in sequence, when compared to this embodiment, is related to performing a similar function, in a similar way, to obtain a similar result, the flow is still one of the embodiments of this present disclosure. Therefore, the steps S1 to S4, the steps S11 to S14 and the flowcharts in FIGS. 2 and 3 are not intended to limit the scope of this present disclosure.

In summary, by implementing the method of trailer safety control, the first processing unit 11 of the trailer safety device 1 may, when the trailer connection status indicates that the trailer is separated from the tow vehicle, automatically transmit the alert notification to the electronic device 2 via the first wireless communication unit 15 to alert the driver of the tow vehicle, thereby preventing a situation where a driver does not notice the separation of the trailer from the tow vehicle in time which would lead to more serious traffic safety hazards. In addition, the first processing unit 11 of the trailer safety device 1 may provide the battery status that includes the percentage value of the amount of the electric power currently remaining in the battery 16 to the electronic device 2 for viewing by the driver, and by virtue of this arrangement, the driver is able to check whether the remaining electric power in the battery 16 is sufficient for activating the electronic braking system 601 of the trailer.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of trailer safety control, the method to be implemented by a trailer safety system that includes a trailer safety device adapted to be mounted on a trailer,
the trailer safety device including a processing unit, a charging unit, a state monitor and a wireless communication unit that are electrically connected to the processing unit, a battery that is electrically connected to the charging unit, and a breakaway switch that is electrically connected to the battery,
the breakaway switch having a non-conducting state and a conducting state, being caused to switch from the non-conducting state to the conducting state when the trailer is separated from a tow vehicle, and, when the breakaway switch is in the conducting state, providing electric power from the battery to an electronic braking system that is mounted on the trailer for activating the electronic braking system,
the method comprising:
when the charging unit receives an external power supply from an external power supply terminal, the processing unit controlling the charging unit to charge the battery using the external power supply, and the processing unit operating in an active mode that includes operations of,
establishing a wireless network connection with an electronic device via the wireless communication unit,
controlling the state monitor to monitor trailer states that include a trailer connection status indicating a status of connection of the trailer with the tow vehicle, and
transmitting an alert notification to the electronic device via the wireless communication unit when the trailer connection status indicates that the trailer is separated from the tow vehicle.

2. The method as claimed in claim 1, wherein the trailer states further include a battery status indicating an amount of electric power currently remaining in the battery; and
wherein the active mode further includes an operation of the processing unit providing the trailer states to the electronic device via the wireless communication unit to make the electronic device display the trailer states.

3. The method as claimed in claim 1, further comprising:
in a case that the charging unit does not receive the external power supply from the external power supply terminal but receives a solar power supply from a solar panel, the processing unit controlling the charging unit to charge the battery using the solar power supply from the solar panel, and the processing unit operating in a sleeping mode that includes an operation of cutting off the wireless network connection with the electronic device.

4. The method as claimed in claim 1, the trailer safety system further including the electronic device, the method further comprising:
the electronic device determining whether an alert requirement is met, and storing a current position of the electronic device as an alert location and outputting the alert location when the electronic device determines that the alert requirement is met, and
wherein the alert requirement is that the electronic device loses the wireless network connection with the processing unit when the processing unit is operating in the active mode.

5. A trailer safety device adapted to be mounted on a trailer, the trailer including an electronic braking system, said trailer safety device comprising:
a processing unit adapted to be wirelessly connected to an electronic device;
a charging unit electrically connected to said processing unit;
a state monitor electrically connected to said processing unit;
a wireless communication unit electrically connected to said processing unit;
a battery electrically connected to said charging unit; and
a breakaway switch electrically connected to said battery, having a non-conducting state and a conducting state, and adapted to be electrically connected to the electronic braking system of the trailer, said breakaway switch being caused to switch from the non-conducting state to the conducting state when the trailer is separated from a tow vehicle, thereby providing electric power from said battery to the electronic braking system of the trailer for activating the electronic braking system,
wherein said processing unit is configured to, when said charging unit receives an external power supply from an external power supply terminal,
control said charging unit to charge said battery using the external power supply, and
operate in an active mode, and
wherein said processing unit is further configured to, when operating in the active mode,
establish a wireless network connection with the electronic device via said wireless communication unit,
control said state monitor to monitor trailer states that include a trailer connection status indicating a status of connection of the trailer with the tow vehicle, and
transmit an alert notification to the electronic device via said wireless communication unit when the trailer connection status indicates that the trailer is separated from the tow vehicle.

6. The trailer safety device as claimed in claim 5, wherein the trailer states further include a battery status indicating an amount of electric power currently remaining in said battery; and
wherein said processing unit is further configured to, when operating in the active mode, provide the trailer states to the electronic device via said wireless communication unit to make the electronic device display the trailer states.

7. The trailer safety device as claimed in claim 5, wherein said processing unit is further configured to, in a case that said charging unit does not receive the external power supply from the external power supply terminal but receives a solar power supply from a solar panel,
control said charging unit to charge said battery using the solar power supply from the solar panel, and
operate in a sleeping mode; and
wherein said processing unit is further configured to, when operating in the sleeping mode, cut off the wireless network connection with the electronic device.

8. A trailer safety system, comprising:
a trailer safety device adapted to be mounted on a trailer, the trailer including an electronic braking system, said trailer safety device including
a processing unit adapted to be wirelessly connected to an electronic device,
a charging unit electrically connected to said processing unit,
a state monitor electrically connected to said processing unit,
a wireless communication unit electrically connected to said processing unit,
a battery electrically connected to said charging unit, and
a breakaway switch electrically connected to said battery, having a non-conducting state and a conducting state, and adapted to be electrically connected to the electronic braking system of the trailer, said breakaway switch being caused to switch from the non-conducting state to the conducting state when the trailer is separated from a tow vehicle, thereby providing electric power from said battery to the electronic braking system of the trailer for activating the electronic braking system,
wherein said processing unit is configured to, when said charging unit receives an external power supply from an external power supply terminal,
control said charging unit to charge said battery using the external power supply, and
operate in an active mode, and
wherein said processing unit is further configured to, when operating in the active mode,
establish a wireless network connection with the electronic device via said wireless communication unit,
control said state monitor to monitor trailer states that include a trailer connection status indicating a status of connection of the trailer with the tow vehicle, and
transmit an alert notification to the electronic device via said wireless communication unit when the trailer connection status indicates that the trailer is separated from the tow vehicle.

9. The trailer safety system as claimed in claim 8, wherein the trailer states further include a battery status indicating an amount of electric power currently remaining in said battery; and
wherein said processing unit is further configured to, when operating in the active mode, provide the trailer states to the electronic device via said wireless communication unit to make the electronic device display the trailer states.

10. The trailer safety system as claimed in claim 8, wherein said processing unit is further configured to, in a case that said charging unit does not receive the external power supply from the external power supply terminal, but receives a solar power supply from a solar panel,
control said charging unit to charge said battery using the solar power supply from the solar panel, and
operate in a sleeping mode; and
wherein said processing unit is further configured to, when operating in the sleeping mode, cut off the wireless network connection with the electronic device.

11. The trailer safety system as claimed in claim 8, further comprising the electronic device that is configured to determine whether an alert requirement is met, and to store a current position of the electronic device as an alert location and output the alert location when the electronic device determines that the alert requirement is met, and
wherein the alert requirement is that the electronic device loses the wireless network connection with said processing unit when said processing unit is in the active mode.
